(19) United States
(12) Patent Application Publication
(10) Pub. No.: US 2020/0235946 A1
(43) Pub. Date: Jul. 23, 2020

(54) SECURITY MANAGEMENT SYSTEM FOR VEHICLE COMMUNICATION, OPERATING METHOD THEREOF, AND MESSAGE-PROCESSING METHOD OF VEHICLE COMMUNICATION SERVICE PROVISION SYSTEM HAVING THE SAME

(71) Applicant: ELECTRONICS AND TELECOMMUNICATIONS RESEARCH INSTITUTE, Daejeon (KR)

(72) Inventors: Sang-Woo LEE, Daejeon (KR); Hyeok-Chan KWON, Daejeon (KR); Bo-Heung CHUNG, Daejeon (KR)

(21) Appl. No.: 16/718,449

(22) Filed: Dec. 18, 2019

(30) Foreign Application Priority Data
Jan. 23, 2019 (KR) 10-2019-0008803

(51) Int. Cl. H04L 9/32; H04L 9/30

(52) U.S. Cl. CPC H04L 9/3268; H04L 9/30; H04L 9/3247

(57) ABSTRACT

A method of operating a vehicle communication security management system includes receiving a request for registration in a vehicle communication service from a vehicle, generating a security policy corresponding to the request for registration and a pseudonym corresponding to the vehicle, transmitting a request to generate a pseudonym certificate corresponding to the generated pseudonym to a certification center, receiving the pseudonym certificate from the certification center in response to the request to generate the pseudonym certificate, and transmitting vehicle communication service registration information, corresponding to the request for registration in the vehicle communication service, to the vehicle.

### CROSS REFERENCE TO RELATED APPLICATION

This application claims the benefit of Korean Patent Application No. 10-2019-0008803, filed Jan. 23, 2019, which is hereby incorporated by reference in its entirety into this application.

### BACKGROUND OF THE INVENTION

### 1. Technical Field

The present invention relates to a security management system for vehicle communication, a method of operating the same, and a message-processing method of a vehicle communication service provision system including the same.

### 2. Description of Related Art

A vehicular transportation system is evolving into an Information Transportation System (ITS), which is a transportation system for improving the efficiency and safety of transportation by operating and managing the transportation system in a scientific and automated manner by developing and utilizing state-of-the-art transportation technology based on electronics, control and communication technology and traffic information in transportation facilities. Particularly, using vehicle communication technology (e.g., communication between vehicles and communication between a vehicle and a roadside device), the vehicular transportation system is advancing so as to improve vehicle driving safety, provide convenient service to drivers, and ultimately obtain the effects of reducing the incidence of traffic accidents and improving transportation efficiency. Particularly, the effects of increasing transportation efficiency, preventing accidents, and the like may be obtained using vehicle-to-vehicle communication.

### DOCUMENTS OF RELATED ART

(Patent Document 1) Korean Patent Application Publication No. 10-2018-0044368, published on May 2, 2018 and titled “Apparatus, method, and computer program for providing transmission parameters between vehicles”

(Patent Document 2) Chinese Patent Application Publication No. CN105763558, published on Jul. 13, 2016 and titled “Distributed aggregation authentication method having privacy protection function for vehicle-mounted self-organizing network”.

### SUMMARY OF THE INVENTION

An object of the present invention is to provide a vehicle communication security management system, a method of operating the same, and a message-processing method of a vehicle communication service provision system including the same, which define security requirements for a vehicle communication message by identifying a vehicle communication service and specify a security-processing method to suit the security requirements, thereby enabling a suitable security-processing procedure.

A method of operating a vehicle communication security management system according to an embodiment of the present invention may include receiving a request for registration in a vehicle communication service from a vehicle; generating a security policy, corresponding to the request for registration, and a pseudonym corresponding to the vehicle; transmitting a request to generate a pseudonym certificate, corresponding to the generated pseudonym, to a certification center; receiving the pseudonym certificate from the certification center in response to the request to generate the pseudonym certificate; and transmitting vehicle communication service registration information, corresponding to the request for registration, to the vehicle.

In an embodiment, the method may further include receiving a vehicle authentication request from the vehicle; verifying a vehicle ID in response to the vehicle authentication request; and transmitting a vehicle authentication response, corresponding to the verified vehicle ID, to the vehicle.

In an embodiment, verifying the vehicle ID may include authenticating the vehicle using a digital signature method of a public-key cryptography system.

In an embodiment, the request for registration in the vehicle communication service may include a request for designation as an emergency vehicle.

In an embodiment, the security policy may be generated differently depending on the vehicle communication service.

In an embodiment, the vehicle communication service may include at least two of a V2V warning propagation service, a V2V group communication service, a V2V alert service, a V2I warning service, a V2V/V2I information exchange service, a V2D service, and a V2P service.

In an embodiment, the security policy may include at least two of a symmetric key cryptography function, a public-key cryptography function, a digital signature function, and a message integrity verification function.

In an embodiment, the pseudonym may be set to have an expiration time such that the pseudonym is effective for a certain time period.

In an embodiment, the vehicle communication service registration information may include the pseudonym, the pseudonym certificate, and the security policy.

A vehicle communication security management system according to an embodiment of the present invention may include a vehicle ID verification unit for authenticating a vehicle using a digital signature method; a pseudonym generation unit for generating a pseudonym to be assigned to the authenticated vehicle; a security policy generation unit for generating a security policy in response to a request for registration in a vehicle communication service from the authenticated vehicle; a communication unit for receiving a request for authentication and the request for registration in the vehicle communication service from the vehicle and transmitting vehicle communication service registration information including the pseudonym to the vehicle; and a control unit for controlling the vehicle ID verification unit, the pseudonym generation unit, the security policy generation unit, and the communication unit.

In an embodiment, the vehicle communication security management system may further include a display unit for displaying the vehicle communication service registration information.

In an embodiment, the security policy may be configured to determine whether to use a symmetric key cryptography function, a public-key cryptography function, a digital signature function, or a message integrity function depending on the type of the vehicle communication service.

In an embodiment, the communication unit may request a certification center to generate a pseudonym certificate, corresponding to the pseudonym, and receive the generated pseudonym certificate from the certification center.

A message-processing method of a vehicle communication service provision system according to an embodiment of the present invention may include generating a message for a first vehicle communication service; checking a first security policy corresponding to the first vehicle communication service; processing the message depending on the first security policy; and transmitting the processed message.

In an embodiment, processing the message may include encrypting the message, generating a digital signature, or generating an integrity verification code depending on the first security policy.

In an embodiment, the message-processing method may further include receiving a message for a second vehicle communication service; checking a second security policy of the received message; and processing the received message depending on the second security policy.

In an embodiment, processing the received message may include decrypting the received message, verifying a digital signature, or verifying integrity depending on the second security policy.

In an embodiment, when a vehicle requests a vehicle communication security management system to register the vehicle in the first or second vehicle communication service, vehicle communication service registration information including the first or second security policy may be transmitted from the vehicle communication security management system to the vehicle.

In an embodiment, in response to the request to register the vehicle in the first and second vehicle communication services, the vehicle communication security management system may generate the first and second security policies corresponding thereto.

In an embodiment, the vehicle communication security management system may generate a pseudonym for the vehicle in response to the request to register the vehicle in the first or second vehicle communication service; request a certification center to generate a pseudonym certificate corresponding to the generated pseudonym; receive the generated pseudonym certificate from the certification center; and transmit the vehicle communication service registration information, including the pseudonym, the pseudonym certificate, and the first or second security policy, to the vehicle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a concept diagram illustrating a general vehicle-communication environment;

FIG. 2 is a view illustrating a service scenario in which, when a traffic accident, such as a rear-end collision or the like, has occurred ahead of a driving vehicle, the vehicle that first discovered the traffic accident propagates a warning to the following vehicle;

FIG. 3 is a view illustrating a service scenario in which, when vehicles having an emergency approach from the rear of a driving vehicle, the emergency vehicle itself or the vehicle that first discovered the emergency vehicle announces the situation to vehicles driving ahead, whereby the emergency vehicles are enabled to go first;

FIG. 4 is a view illustrating a service scenario in which vehicles are classified into a specific group and vehicles in each group communicate with each other;

FIG. 5 is a view illustrating a service scenario in which vehicles communicate with each other in order to enable an arbitrary vehicle to periodically transmit an alert message to nearby vehicles;

FIG. 6 is a view illustrating a service scenario in which infrastructure and a vehicle transmit and receive a warning about a risk that may occur when the vehicle is driving;

FIG. 7 is a view illustrating a service scenario in which a Road-Side-Unit (RSU) is able to transmit road traffic condition information and the like to a vehicle and in which each vehicle transmits driving information pertaining thereto to the RSU;

FIG. 8 is a view illustrating a service authentication method of a vehicle communication service provision system according to the present invention;

FIG. 9 is a view illustrating a vehicle communication security management system according to an embodiment of the present invention;

FIG. 10 is a flowchart illustrating a transmission-message-processing process in a vehicle communication service provision system according to an embodiment of the present invention; and

FIG. 11 is a flowchart illustrating a reception-message-processing process in a vehicle communication service provision system according to an embodiment of the present invention.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that those embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms.

These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, the terms used herein are used merely to describe specific embodiments, and are not intended to limit the present invention. A singular expression includes a plural expression unless a description to the contrary is specifically pointed out in context.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Generally, vehicle communication may be expressed as any of vehicle-to-vehicle (V2V), vehicle-to-infrastructure (V2I), vehicle-to-pedestrian (V2P), vehicle-to-device (V2D), and the like. These may be commonly referred to as ‘V2X’. V2X communication may be used to transmit a message containing a forward collision warning, a rear emergency vehicle warning, traffic accident information, or the like. Such a message is required to be processed so as to satisfy security requirements before being transmitted, and a receiver determines security conformance through a security-processing-checking procedure for the message on which security processing has been performed. That is, the encrypted message is decrypted, whereby what the received message means is detected. Also, in the case of a digitally signed message, the validity of a digital signature is checked, whereby the sender of the message is authenticated and the possibility that the message is forged or falsified may be checked.

However, this security-processing procedure has a problem in which a long computation time is required for a sender to perform security processing on a message, compared to the case in which no security processing is performed on the message. Also, a receiver is required to spend a lot of computation time processing the message on which security processing has been performed compared to a message on which no security processing has been performed. Particularly, in a vehicle communication environment, short messages are frequently transmitted and received (e.g., ten messages per second). Therefore, when security processing is applied to all of the messages, a high computational load is imposed on the sender and the receiver.

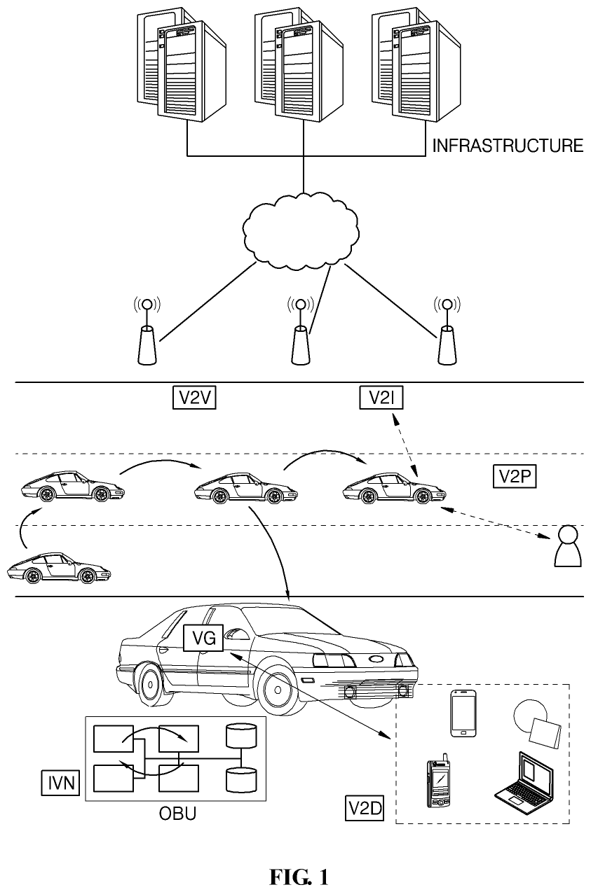

FIG. 1 is a concept diagram illustrating a general vehicle-communication environment. Referring to FIG. 1, vehicle communication may include V2X, which is vehicle external communication, and an in-vehicle-network (IVN). Here, V2X may be expressed as Vehicle-to-Vehicle (V2V), Vehicle-to-Infrastructure (V2I), Vehicle-to-Pedestrian (V2P), Vehicle-to-Device (V2D), or the like. A Road-Side-Unit (RSU) is a communication base station installed on the side of a road along which a vehicle drives. V2I indicates communication between a vehicle and an RSU or communication between a vehicle and a control server or security management server connected with an RSU. The RSU may be implemented using dedicated short-range communications (DSRC) technology, LTE, and 5G mobile communication.

Hereinafter, various embodiments of a communication service scenario will be described.

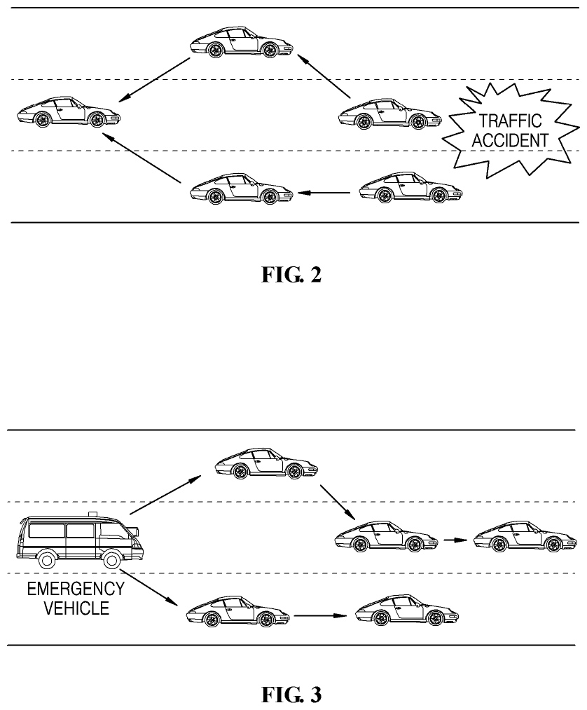

FIG. 2 is a view illustrating the first scenario of a V2V warning propagation service. Referring to FIG. 2, V2V warning propagation (in the event of a forward collision accident) is configured such that, when a traffic accident, such as a rear-end accident or the like, has occurred ahead of a driving vehicle, the vehicle that first discovered the traffic accident propagates a warning to a following vehicle.

FIG. 3 is a view illustrating the second scenario of the V2V warning propagation service. Referring to FIG. 3, the V2V warning propagation service (for a rear emergency vehicle) is configured such that when an emergency vehicle (e.g., an ambulance) behind a driving vehicle approaches, the vehicle that first discovered the emergency vehicle or the emergency vehicle itself announces the situation to other vehicles driving ahead, whereby the emergency vehicle may go first. FIG. 2 and FIG. 3 correspond to a vehicle-to-vehicle communication service in which a message is transmitted in a specific direction.

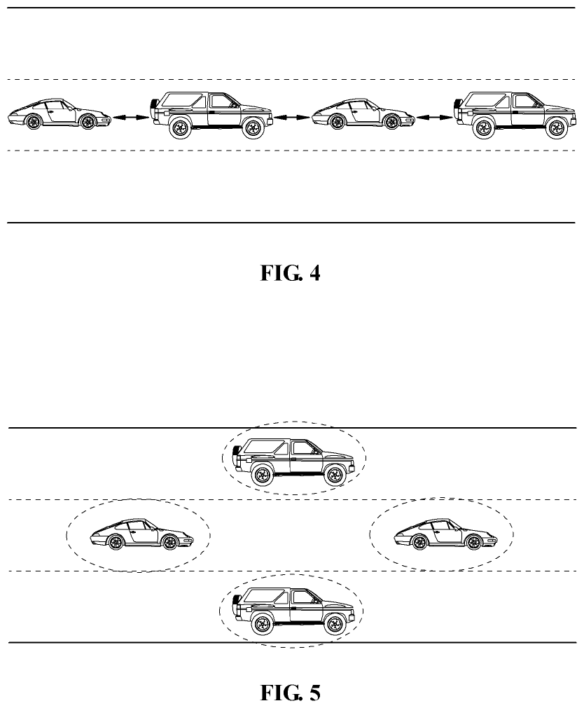

FIG. 4 is a view illustrating a scenario of a V2V group communication service. Referring to FIG. 4, the V2V group communication service indicates communication between vehicles that are members of each group when the vehicles are classified into a specific group. Here, the group may be previously set and managed, or may be dynamically assigned.

FIG. 5 is a view illustrating a scenario of a V2V alert service. Referring to FIG. 5, the V2V alert service is a vehicle-to-vehicle communication service for enabling an arbitrary vehicle to periodically transmit an alert message to nearby vehicles. This alert message may contain content, such as the current speed of the vehicle transmitting the message, the direction in which the vehicle is driving, information about whether the vehicle is using a brake, and the like. Such a message may be used in order to improve the travelling safety of nearby vehicles.

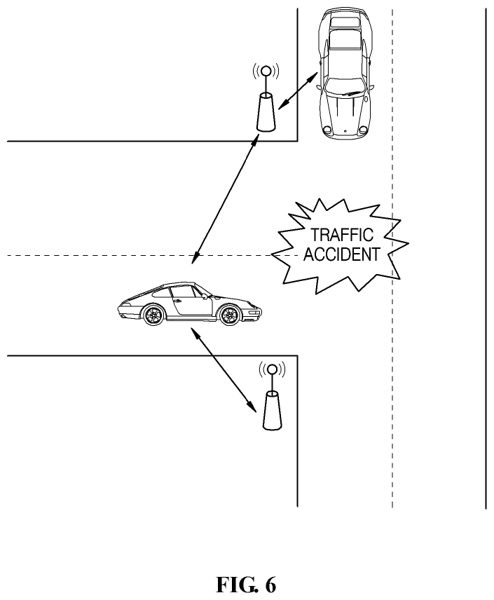

FIG. 6 is a view illustrating a scenario of a V2I warning service. Referring to FIG. 6, the V2I warning service is configured such that a vehicle and infrastructure transmit and receive a warning about a risk that may be caused when the vehicle is driving. For example, there may be provided a service in which, when the risk of a collision accident at the intersection is detected, a warning message is transmitted from infrastructure to a vehicle that is about to enter the intersection.

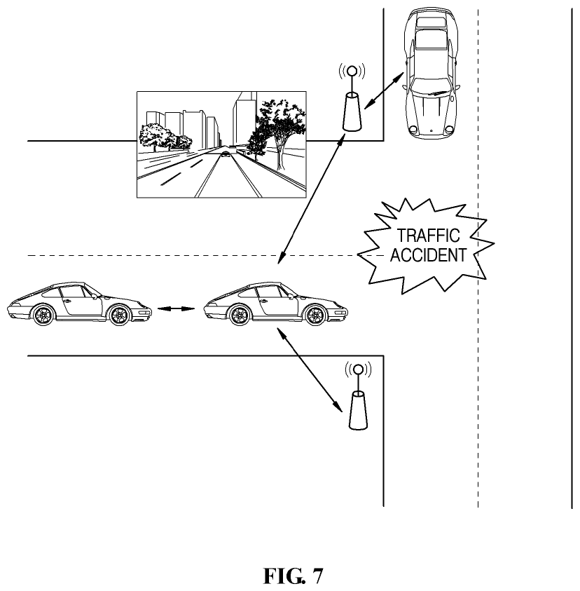

FIG. 7 is a view illustrating a scenario of a V2V/V2I information exchange service. Referring to FIG. 7, V2V/V2I information exchange is configured such that a Road-Side-Unit (RSU) is able to transmit road traffic condition information and the like to a vehicle and such that each vehicle transmits driving information pertaining thereto to the RSU. The driving information pertaining to each vehicle may be used for signal control, traffic flow control, and the like. Each vehicle may refer to the traffic condition information provided by the RSU when it sets a travel route.

Also, V2D indicates communication between the communication unit of a vehicle and a nomadic device, that is, a terminal such as a mobile phone, carried by a passenger or driver in the vehicle. Accordingly, the speed, the direction information, and the like of the vehicle may be output via the mobile phone. Also, a service in which music on the mobile phone is transmitted to the audio equipment of the vehicle may be provided.

Also, V2P indicates communication between a vehicle and the nomadic device of a pedestrian, that is, a mobile phone, or communication between a vehicle and the nomadic device of a bicycle rider, that is, a mobile phone. In V2P, the nomadic device that communicates with the vehicle may measure the position and speed information of the pedestrian or the bicycle, in which case the nomadic device is a device having the function of communicating with the vehicle.

Table 1 shows an embodiment of security requirements required for each of the above-described services.

TABLE 1

| | V2V | | | | V2V/V2I | | |
|---|---|---|---|---|---|---|---|
| | warning | V2V group | V2V | V2I | information | | |
| | propagation | communication | alert | warning | exchange | V2D | V2P |
| confidentiality | — | O | — | — | O | O | O |
| (general) | | | | | | | |
| confidentiality | O | O | O | p | O | O | O |
| (private | | | | | | | |
| information) | | | | | | | |
| integrity | O | O | O | O | O | O | O |
| availability | O | O | O | O | O | p | O |
| non- | O | O | O | O | O | O | O |
| repudiation | | | | | | | |
| authentication | O | p | O | O | O | O | O |
| responsibility | O | O | O | O | O | O | O |
| approval | — | — | — | — | O | O | — |

The security requirements may be generally defined as follows.

Here, ‘confidentiality (general)’ indicates that the content of information is not disclosed to an unauthorized entity through data encryption, ‘confidentiality (private information)’ indicates that the content of private information is not disclosed to an unauthorized entity through encryption of the private information, ‘integrity’ indicates checking whether data is forged/falsified, ‘availability’ indicates that an authorized entity has no restrictions when using a vehicle communication message or function, ‘non-repudiation’ indicates assurance that the sender of data cannot deny having made a transmission, ‘authentication’ indicates that an entity proves that the entity is the rightful owner of an ID, ‘responsibility’ indicates that an individual must be uniquely identified in a system such that, when necessary, the person involved may be tracked by recording information about who takes an action, when the action takes place, and which action takes place in a vehicle communication environment. Also, ‘approval’ indicates granting permissions to access a specific service.

As shown in Table 1, these security requirements may be selectively applied to vehicle communication services. As described above, Table 1 presents that not all of the security requirements need to be satisfied for all of the services. In Table 1, ‘O’ indicates that the corresponding requirement is necessary, ‘-’ indicates that the corresponding requirement is not necessary, and ‘p’ indicates that the corresponding requirement is partly necessary. That is, in the case of V2V warning propagation, V2V alert, and V2I warning service, a vehicle message is not required to be encrypted. That is, because V2V warning propagation is for propagating information about whether an accident occurs on the road ahead or for transmitting a message saying that there is an emergency vehicle following, encryption is not required.

The content in Table 1 is merely an embodiment, and the presence/absence of each security requirement may be set differently depending on a vehicle communication security policy.

Table 2 shows functions that must be fulfilled by a vehicle communication security system in order to satisfy the above-described security requirements in Table 1. That is, in the case of V2V warning propagation, V2V alert, and V2I warning service, a symmetric key cryptography function for encrypting a vehicle message is not required.

TABLE 2

| | V2V | | | | V2V/V2I | | |
|---|---|---|---|---|---|---|---|
| | warning | V2V group | V2V | V2I | information | | |
| | propagation | communication | alert | warning | exchange | V2D | V2P |
| symmetric key | — | O | — | — | O | O | O |
| cryptography | | | | | | | |
| function | | | | | | | |
| public-key | — | O | — | — | O | O | O |
| cryptography | | | | | | | |
| function | | | | | | | |
| digital | O | O | O | O | O | O | O |
| signature | | | | | | | |
| function | | | | | | | |
| message | O | O | O | O | O | O | O |
| integrity | | | | | | | |
| verification | | | | | | | |
| function | | | | | | | |

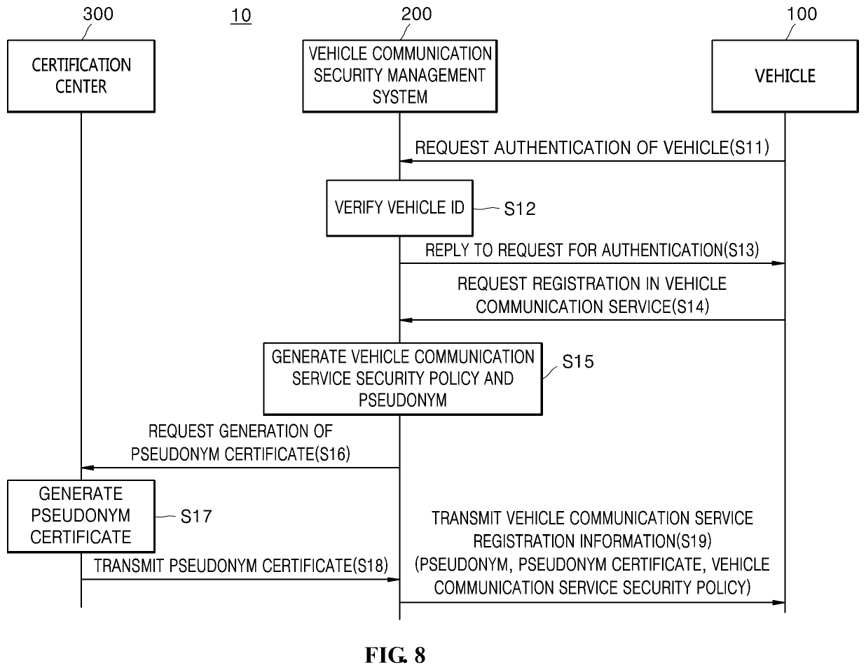

FIG. 8 is a view illustrating a service authentication method of a vehicle communication service provision system 10 according to the present invention. A vehicle 100 may request a vehicle communication security management system 200 to authenticate the vehicle at step S11. In an embodiment, vehicle authentication may be performed using a digital signature method of a public-key cryptography system. That is, a message signed with the private key of the vehicle 100 may be transmitted to the vehicle communication security management system 200.

The vehicle communication security management system 200 may verify a vehicle ID at step S12 in response to the request from the vehicle 100 to authenticate the vehicle. In an embodiment, the message signed with the private key of the vehicle 100 may be verified using the public key of the vehicle 100.

The vehicle communication security management system 200 may determine whether the vehicle ID is present in a vehicle ID database stored therein and transmit a vehicle authentication response, corresponding to the determination result, to the vehicle 100 at step S13. In an embodiment, the vehicle communication security management system 200 transmits information about whether the verification of the digital signature succeeds to the vehicle 100.

The vehicle 100, the authentication of which succeeds, may request the vehicle communication security management system 200 to register the vehicle 100 in a vehicle communication service at step S14.

In an embodiment, the request for registration in the vehicle communication service may include a specific vehicle state. That is, in order to enable a police car or an emergency vehicle to define itself as an emergency vehicle and to transmit a message for a V2V warning propagation service, the request may include vehicle information, such as a request to designate the vehicle as an emergency vehicle. In an embodiment, the request for registration in the vehicle communication service may be transmitted using the mobile communication device of a driver or a communication device installed in the vehicle.

Subsequently, the vehicle communication security management system 200 may establish a vehicle communication service security policy and generate a pseudonym for the vehicle at step S15 in response to the request for registration. In an embodiment, the vehicle communication security management system 200 may establish a security policy for each vehicle communication service in Table 2.

The vehicle communication security management system 200 may request a certification center 300 to generate a pseudonym certificate for the generated pseudonym at step S16.

In an embodiment, the pseudonym is a temporary ID assigned to each vehicle, and information associated with the actual ID of the vehicle is prevented from being exposed outside during vehicle communication. Accordingly, the position privacy of the vehicle may be protected. According to an embodiment, the pseudonym may be set to have an expiration time such that the pseudonym is effective for a certain time period.

The certification center 300 may generate a pseudonym certificate for the pseudonym at step S17 in response to the request to generate the pseudonym certificate. In an embodiment, the pseudonym certificate may be a digitally signed message of the certification center 300 for the pseudonym. Through the pseudonym certificate, the validity of the pseudonym may be guaranteed.

The certification center 300 may transmit the generated pseudonym certificate to the vehicle communication security management system 200 at step S18. The vehicle communication security management system 200 may transmit the pseudonym and the pseudonym certificate to the vehicle at step S19.

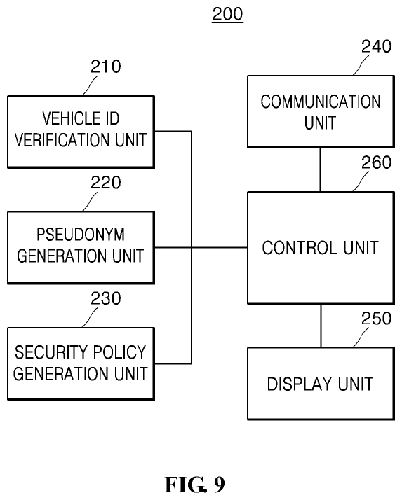

FIG. 9 is a view illustrating a vehicle communication security management system 200 according to an embodiment of the present invention. Referring to FIG. 9, the vehicle communication security management system 200 may include a vehicle ID verification unit 210, a pseudonym generation unit 220, a security policy generation unit 230, a communication unit 240, a display unit 250, and a control unit 260.

The vehicle ID verification unit 210 may be implemented so as to verify a vehicle ID in order to authenticate the vehicle 100 that requests a vehicle communication service.

The pseudonym generation unit 220 may be implemented so as to generate a pseudonym to be assigned to the vehicle 100.

The security policy generation unit 230 may be implemented so as to establish a security policy, such as symmetric key cryptography, public-key cryptography, a digital signature, message integrity, and the like, depending on the type of communication service of vehicles.

The communication unit 240 may be implemented so as to receive a message for requesting authentication and a message for requesting registration in a vehicle communication service from the vehicle 100 and to transmit vehicle communication service registration information in which the pseudonym generated by the pseudonym generation unit 220 is included.

The display unit 250 may be implemented so as to display pieces of information.

The control unit 260 may be implemented so as to control the overall operation.

Hereinafter, a message-processing procedure of the sender and receiver of a vehicle communication message according to the present invention will be described.

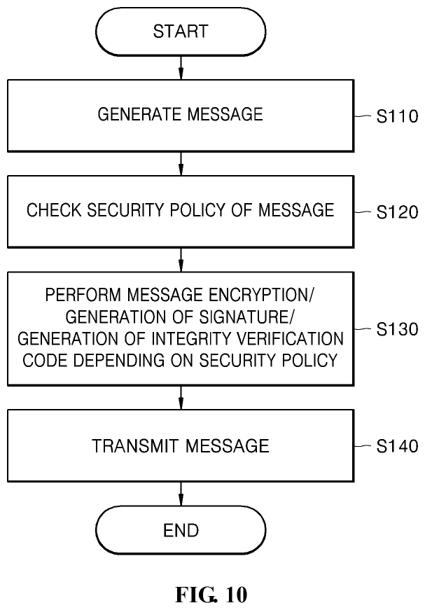

FIG. 10 is a flowchart illustrating a transmission-message-processing process in a vehicle communication service provision system according to an embodiment of the present invention. Referring to FIGS. 8 to 10, the vehicle-message processing operation of a vehicle that transmits a message (or a sender) may proceed as follows.

A vehicle communication message, corresponding to the vehicle communication service (first vehicle communication service) to be used, may be generated at step S110. A security policy (first security policy) based on the communication service of the message may be checked at step S120. Depending on the security policy, encryption of the message, generation of a digital signature, and/or generation of an integrity verification code may be performed at step S130. The message based on the security policy of the communication service to be used may be transmitted to the reception vehicle (or the receiver) at step S140.

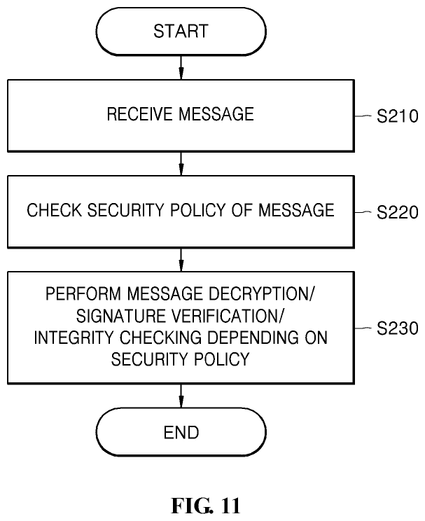

FIG. 11 is a flowchart illustrating a reception-message-processing process in a vehicle communication service provision system according to an embodiment of the present invention. Referring to FIGS. 8 to 11, the vehicle-message-processing operation of a vehicle that receives a message (or a receiver) may proceed as follows.

A message may be received from a sender at step S210. The security policy (second security policy) of the received message may be checked at step S220. Depending on the checked security policy, decryption of the message, verification of a digital signature, and/or verification of message integrity may be performed at step S230.

According to an embodiment, some or all of the steps and/or operations may be at least partially implemented or performed using one or more processors that execute instructions, programs, interactive data structures, and client and/or server components stored in one or more nonvolatile computer-readable media. The one or more nonvolatile computer-readable media may be, for example, software, firmware, hardware, and/or any combination thereof. Also, the functionality of any “module” discussed herein may be implemented in software, firmware, hardware, and/or any combination thereof.

The one or more nonvolatile computer-readable media and/or means for implementing or performing one or more operations, steps, and modules of the embodiments of the present invention may include application-specific integrated circuits (ASICs), standard integrated circuits, controllers executing suitable instructions (including microcontrollers and/or embedded controllers), field-programmable gate arrays (FPGAs), complex programmable logic devices (CPLDs), and the like, but the components that may be included therein are not limited to these examples.

According to the present invention, because a security-processing procedure of a vehicle communication message is configured such that a security policy is established based on the type of communication service, security processing optimized for the communication service may be performed. That is, a public-key cryptography algorithm requires a lot of computation time, but security processing is performed only for the service that requires the corresponding algorithm, whereby overhead arising from processing of messages between the sender and receiver of the vehicle communication message may be reduced.

Through the vehicle communication service authentication method, the vehicle that intends to register itself in a vehicle communication service is authenticated, whereby a security accident in which the vehicle communication service is invaded by a malicious attacker may be prevented.

Also, the vehicle communication service authentication method according to the present invention is advantageous in that the privacy of a vehicle may be protected because the actual ID of the vehicle is not exposed.

According to the present invention, when a security-processing procedure for a vehicle communication message is preformed, a security policy is established depending on the type of communication service, whereby security processing optimized depending on the communication service may be performed. That is, a public-key cryptography algorithm requires a lot of computation time, but security processing is performed only for the service that requires the corresponding algorithm, whereby overhead arising from processing of messages between the sender and receiver of the vehicle communication message may be reduced.

A security management system for vehicle communication, a method of operating the same, and a message-processing method of a vehicle communication service provision system including the same according to an embodiment of the present invention authenticate a vehicle that intends to register itself in a vehicle communication service, thereby preventing a security accident in which the vehicle communication service is invaded by a malicious attacker.

Also, a security management system for vehicle communication, a method of operating the same, and a message-processing method of a vehicle communication service provision system including the same according to an embodiment of the present invention prevent the actual ID of a vehicle from being exposed, thereby protecting the privacy of the vehicle.

Meanwhile, the above description is merely of specific embodiments for practicing the present invention. The present invention encompasses not only concrete and available means but also the technical spirit corresponding to abstract and conceptual ideas that may be used as future technology.

1. A method of operating a vehicle communication security management system, comprising:
receiving a request for registration in a vehicle communication service from a vehicle;
generating a pseudonym corresponding to the vehicle in response to the request for registration;
transmitting a request to generate a pseudonym certificate, corresponding to the generated pseudonym, to a certification center;
receiving the pseudonym certificate from the certification center in response to the request to generate the pseudonym certificate; and
transmitting vehicle communication service registration information, corresponding to the request for registration, to the vehicle,
wherein the vehicle communication service corresponds a service scenario of one of a V2V warning propagation service, a V2V group communication service, a V2V alert service, a V2I warning service, a V2V/V2I information exchange service, a V2D service, and a V2P service, wherein the vehicle communication service requires different security requirements according to the service scenario, and
wherein the vehicle communication service requires at least the security requirements of integrity, non-reputation and accountability.

2. The method of claim 1, further comprising:
receiving a vehicle authentication request from the vehicle;
verifying a vehicle ID in response to the vehicle authentication request; and
transmitting a vehicle authentication response, corresponding to the verified vehicle ID, to the vehicle.

3. The method of claim 2, wherein verifying the vehicle ID comprises:
authenticating the vehicle using a digital signature method of a public-key cryptography system.

4. The method of claim 1, wherein the request for registration in the vehicle communication service includes a request for designation as an emergency vehicle.

5. (canceled)

6. (canceled)

7. (canceled)

8. The method of claim 1, wherein the pseudonym is set to have an expiration time such that the pseudonym is effective for a certain time period.

9. The method of claim 1, wherein the vehicle communication service registration information includes the pseudonym and the pseudonym certificate.

10. A vehicle communication security management system, comprising:
a vehicle ID verification unit for authenticating a vehicle using a digital signature method;
a pseudonym generation unit for generating a pseudonym to be assigned to the authenticated vehicle;
a communication unit for receiving a request for authentication and the request for registration in the vehicle communication service from the vehicle and transmitting vehicle communication service registration information including the pseudonym to the vehicle; and
a control unit for controlling the vehicle ID verification unit, the pseudonym generation unit, and the communication unit,
wherein the vehicle communication service corresponds a service scenario of one of a V2V warning propagation service, a V2V group communication service, a V2V alert service, a V2I warning service, a V2V/V2I information exchange service, a V2D service, and a V2P service,
wherein the vehicle communication service requires different security requirements according to the service scenario, and
wherein the vehicle communication service requires at least the security requirements of integrity, non-reputation and accountability.

11. The vehicle communication security management system of claim 10, further comprising:
a display unit for displaying the vehicle communication service registration information.

12. (canceled)

13. The vehicle communication security management system of claim 10, wherein the communication unit requests a certification center to generate a pseudonym certificate, corresponding to the pseudonym, and receives the generated pseudonym certificate from the certification center.

14. A message-processing method of a vehicle communication service provision system, comprising:
generating a message for a first vehicle communication service;
checking a first security policy corresponding to the first vehicle communication service;
processing the message depending on the first security policy; and
transmitting the processed message.

15. The message-processing method of claim 14, wherein processing the message comprises:
encrypting the message, generating a digital signature, or generating an integrity verification code depending on the first security policy.

16. The message-processing method of claim 14, further comprising:
receiving a message for a second vehicle communication service;
checking a second security policy of the received message; and
processing the received message depending on the second security policy.

17. The message-processing method of claim 16, wherein processing the received message comprises:
decrypting the received message, verifying a digital signature, or verifying integrity depending on the second security policy.

18. The message-processing method of claim 16, wherein, when a vehicle requests a vehicle communication security management system to register the vehicle in the first or second vehicle communication service, vehicle communication service registration information including the first or second security policy is transmitted from the vehicle communication security management system to the vehicle.

19. The message-processing method of claim 18, wherein, in response to the request to register the vehicle in the first and second vehicle communication services, the vehicle communication security management system generates the first and second security policies corresponding thereto.

20. The message-processing method of claim 19, wherein the vehicle communication security management system generates a pseudonym for the vehicle in response to the request to register the vehicle in the first or second vehicle communication service; requests a certification center to generate a pseudonym certificate corresponding to the generated pseudonym; receives the generated pseudonym certificate from the certification center; and transmits the vehicle communication service registration information, including the pseudonym, the pseudonym certificate, and the first or second security policy, to the vehicle.
